(19) United States
(12) Patent Application Publication
(10) Pub. No.: US 2024/0202269 A1
(43) Pub. Date: Jun. 20, 2024

(54) METHOD FOR DYNAMICALLY PRE-FETCHING FOLDER TREE AND CLOUD SERVER FOR EXECUTING THE SAME

(71) Applicant: CLOUDIKE INC., Gyeonggi-do (KR)

(72) Inventor: SUN UNG LEE, Seoul (KR)

(21) Appl. No.: 18/515,673

(22) Filed: Nov. 21, 2023

(30) Foreign Application Priority Data
Dec. 15, 2022 (KR) 10-2022-0175527

(51) Int. Cl. G06F 16/957

(52) U.S. Cl. CPC G06F 16/9574

(57) ABSTRACT

A cloud server is a cloud server having a folder tree, and transferring meta data on a folder included in the folder tree to a local terminal in response to a pre-fetch request of the local terminal. The cloud server includes a pattern learning unit to learn access patterns of users who access the folder tree, when the local terminal initially accesses a first folder in the folder tree, an access prediction unit to determine a second folder predicted to be accessed by the local terminal after accessing the first folder based on information on the first folder, information on the local terminal, and learning data learned in the pattern learning unit, and a meta data transfer unit to transfer meta data on the second folder to the local terminal to allow the local terminal to pre-fetch the meta data on the second folder before accessing the second folder.

### PRIORITY

This application claims the benefit under 35 USC § 119 of Korean Patent Application No. 10-2022-0175527 filed on Dec. 15, 2022, in the Korean Intellectual Property Office, the entire disclosure of which is incorporated herein by reference for all purposes.

### BACKGROUND

The present disclosure relates to a technique for dynamically pre-fetching a folder tree.

With the development of network technologies, data stored in a terminal (e.g., a desktop, a laptop, a portable device, etc.) used by a user is stored in a cloud storage, and the user may use the data stored in the cloud storage anytime, anywhere using his or her account whenever necessary. The user may upload or download a file through the cloud storage, and check a modified file in real time through file sharing and synchronization.

At this time, files stored in each folder of the cloud storage may be displayed on a local terminal through a folder tree, and the user may intuitively check the hierarchical structure of each folder through the folder tree. The user may access each folder through the folder tree, and thus, may access a desired file more quickly.

Meanwhile, in order to view such a folder tree through the local terminal, the local terminal should pre-fetch meta data on each folder of the folder tree from a cloud server. However, if the number of folders in the folder tree is very large or the structure of the folder tree is complicated, it takes a large amount of time for the pre-fetch, and in this case, it is difficult to quickly display the folder tree in the local terminal. In addition, in this case, it is difficult to display the entire folder tree on a limited-size screen.

### SUMMARY

Embodiments of the present disclosure are to determine a folder predicted to be accessed by a local terminal based on access patterns of users who access a folder tree, and to more efficiently view the folder tree in the local terminal through dynamic pre-fetch with respect to the determined folder.

In accordance with an exemplary embodiment of the present disclosure, a cloud server having a folder tree, and transferring meta data on one or more folders included in the folder tree to a local terminal in response to a pre-fetch request of the local terminal includes a pattern learning unit configured to learn access patterns of users who access the folder tree, when the local terminal initially accesses a first folder in the folder tree, an access prediction unit configured to determine one or more second folders predicted to be accessed by the local terminal after accessing the first folder based on information on the first folder, information on the local terminal, and learning data learned in the pattern learning unit, and a meta data transfer unit configured to transfer meta data on the second folder to the local terminal so as to allow the local terminal to pre-fetch the meta data on the second folder before accessing the second folder.

The pattern learning unit may learn the access patterns of the users by matching user information including at least one of a user's affiliation, position, and job duties with folder information including at least one of a folder path through which the user has accessed the folder tree for a set period of time, the number of folders accessed, and an access time zone during which the user has accessed the folder tree.

The access prediction unit may select another local terminal corresponding to information on the local terminal from the user information, and may determine from the folder information the second folder in consideration of the count or ratio of accesses with respect to a folder accessed next by the another local terminal after accessing the first folder.

The access prediction unit may select another local terminal corresponding to the information on the local terminal by respectively comparing the affiliation, position, and job duties of a user carrying the local terminal with the affiliation, position, and job duties of a user carrying the another local terminal.

When the local terminal sequentially accesses one or more other folders other than the first folder in the folder tree after initially accessing the first folder, the access prediction unit may determine the second folder based on the information on the first folder, information on the other folders, the information on the local terminal, and the learning data learned in the pattern learning unit.

The meta data on the second folder may be dynamically changed according to user information corresponding to each local terminal and a pre-fetch request time zone of the each local terminal.

The folder tree may be dynamically displayed in the local terminal according to the meta data, wherein folders in the folder tree may be displayed differently from each other in the local terminal according to whether the meta data is received.

In accordance with another exemplary embodiment of the present disclosure, a method for dynamically pre-fetching a folder tree provided in a cloud server having a folder tree and receiving a pre-fetch request for the folder tree from a local terminal includes in a pattern learning unit, learning access patterns of users who access the folder tree, in an access prediction unit, when the local terminal initially accesses a first folder in the folder tree, determining one or more second folders predicted to be accessed by the local terminal after accessing the first folder based on information on the first folder, information on the local terminal, and learning data learned in the pattern learning unit, and in a meta data transfer unit, transferring meta data on the second folder to the local terminal so as to allow the local terminal to pre-fetch the meta data on the second folder before accessing the second folder.

The learning of the access patterns may be learning the access patterns of the users by matching user information including at least one of a user's affiliation, position, and job duties with folder information including at least one of a folder path through which the user has accessed the folder tree for a set period of time, the number of folders accessed, and an access time zone during which the user has accessed the folder tree.

The determining of the second folder may include selecting another local terminal corresponding to the information on the local terminal from the user information, and determining the second folder from the folder information in consideration of the count or ratio of accesses with respect to a folder accessed next by the another local terminal after accessing the first folder.

The selecting of the another local terminal may be selecting another local terminal corresponding to the information on the local terminal by respectively comparing the affiliation, position, and job duties of a user carrying the local terminal with the affiliation, position, and job duties of a user carrying the another local terminal.

The determining of the second folder may be determining, when the local terminal sequentially accesses one or more other folders other than the first folder in the folder tree after initially accessing the first folder, the second folder based on the information on the first folder, information on the other folders, the information on the local terminal, and the learning data learned in the pattern learning unit.

The meta data on the second folder may be dynamically changed according to user information corresponding to each local terminal and a pre-fetch request time zone of the each local terminal.

The folder tree may be dynamically displayed in the local terminal according to the meta data, wherein folders in the folder tree may be displayed differently from each other in the local terminal according to whether the meta data is received.

### BRIEF DESCRIPTION OF THE DRAWINGS

Exemplary embodiments can be understood in more detail from the following description taken in conjunction with the accompanying drawings, in which:

FIG. 1 is a schematic diagram showing a dynamic pre-fetch system of a folder tree in accordance with an exemplary embodiment of the present disclosure;

FIG. 2 is a block diagram showing a detailed configuration of a cloud server in accordance with an exemplary embodiment of the present disclosure;

FIG. 3 is an example of a folder tree in accordance with an exemplary embodiment of the present disclosure;

FIG. 4 is an example showing access patterns of users in accordance with an exemplary embodiment of the present disclosure;

FIG. 5 is a diagram showing a process of predicting an access to a second folder in an access prediction unit in accordance with a first exemplary embodiment of the present disclosure;

FIG. 6 is a diagram showing a process of transferring meta data on the second folder from a meta data transfer unit to a local terminal, and dynamically viewing a folder tree in the local terminal in accordance with the first exemplary embodiment of the present disclosure;

FIG. 7 is a diagram showing a process of predicting an access to a second folder in an access prediction unit in accordance with a second exemplary embodiment of the present disclosure;

FIG. 8 is a diagram showing a process of transferring meta data on the second folder from a meta data transfer unit to a local terminal, and dynamically viewing a folder tree in the local terminal in accordance with the second exemplary embodiment of the present disclosure;

FIG. 9 is an example in which a folder tree in accordance with an exemplary embodiment of the present disclosure is viewed differently according to user information of each local terminal;

FIG. 10 is an example in which a folder tree in accordance with an exemplary embodiment of the present disclosure is viewed differently according to an access time zone of each local terminal;

FIG. 11 is an example showing a user interface for opening a folder tree in accordance with an exemplary embodiment of the present disclosure;

FIG. 12 is an example showing a state in which a folder tree is open according to the user interface of FIG. 11;

FIG. 13 is a diagram showing an example of displaying a sub-folder in a folder tree in accordance with an exemplary embodiment of the present disclosure;

FIG. 14 is a diagram showing an example of displaying a sub-folder in a folder tree in accordance with an exemplary embodiment of the present disclosure;

FIG. 15 is a flowchart for describing a method for dynamically pre-fetching a folder tree in accordance with another exemplary embodiment of the present disclosure; and

FIG. 16 is a block diagram for illustrating and describing a computing environment including a computing device suitable to be used in exemplary embodiments.

### DETAILED DESCRIPTION

Hereinafter, specific embodiments of the present disclosure will be described with reference to the accompanying drawings. The following detailed description is provided to assist in a comprehensive understanding of the methods, devices and/or systems described herein. However, the detailed description is only illustrative, and the present disclosure is not limited thereto.

In describing embodiments of the present disclosure, when a specific description of known technology associated with the present disclosure is deemed to make the gist of the present disclosure unnecessarily vague, the detailed description thereof will be omitted. The terms used below are defined in consideration of functions in the present disclosure, but may vary in accordance with the customary practice or the intention of a user or an operator. Therefore, the terms should be defined based on whole content throughout the present specification. The terms used herein are only for describing the embodiments of the present disclosure, and should not be construed as limited. A singular expression includes a plural meaning unless clearly used otherwise. In the present description, expressions such as “include” or “have” are for referring to certain characteristics, numbers, steps, operations, components, and some or combinations thereof, and should not be construed as excluding the presence or possibility of one or more other characteristics, numbers, steps, operations, components, and some or combinations thereof besides those described.

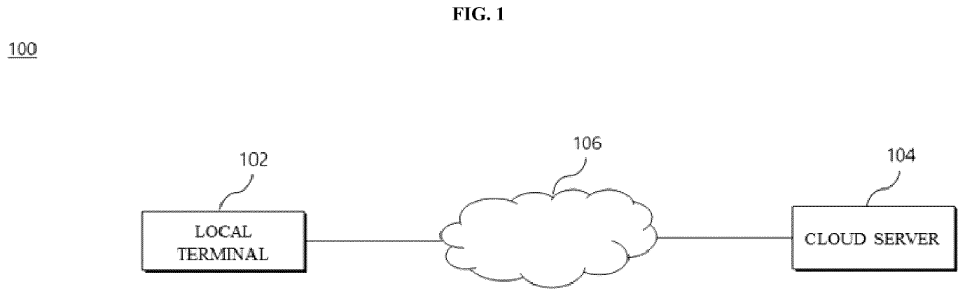

FIG. 1 is a schematic diagram showing a dynamic pre-fetch system 100 of a folder tree in accordance with an exemplary embodiment of the present disclosure. As illustrated in FIG. 1, according to an embodiment of the present disclosure, the dynamic pre-fetch system 100 of a folder tree includes a local terminal 102 and a cloud server 104. The local terminal 102 and the cloud server 104 may be interconnected through a network 106. Here, the network 106 may include, for example, mobile networks such as the Internet, a Wi-Fi network, a 3G network, an LTE network, etc., wire area networks, and the like.

The local terminal 102 is a terminal carried by a user, and may be, for example, a desktop, a laptop, a tablet computer, a smart phone, a personal digital assistant (PDA), a wearable device such as a smart watch, and the like. The user may access a cloud storage (not shown) provided by the cloud server 104 through the local terminal 102. The user may upload or download a file through the cloud storage, and check a modified file in real time through file sharing and synchronization. At this time, files stored in each folder of the cloud storage may be displayed on the local terminal 102 through a folder tree, and the user may intuitively check the hierarchical structure of each folder through the folder tree. Here, a file may include, for example, a document, a picture, an image, a video file, and the like, but the type of the file is not particularly limited.

In addition, the local terminal 102 may forward a pre-fetch request for displaying the folder tree to the cloud server 104. In the present embodiments, the pre-fetch request refers to a request to retrieve meta data on folders in the folder tree that is required to display the folder tree in the local terminal 102. Here, the meta data on the folders may be the name of each folder, and the name, number, size, extension, etc., of a file included in each folder. The pre-fetch request may be automatically triggered when the local terminal 10 initially accesses any folder in the folder tree and then transferred to the cloud server 104.

The cloud server 104 is a device that manages the cloud storage, thereby providing various cloud services. In the present embodiments, the cloud storage is a storage in which files are stored. The user may access the cloud storage through the local terminal 102 to perform file access, file modification, file creation, file upload, file download, and the like. The files may be stored in each folder in a hierarchical structure, that is, in the form of a folder tree, and the cloud server 104 may transfer meta data on folders in the folder tree to the local terminal 102 in response to a pre-fetch request of the local terminal 102.

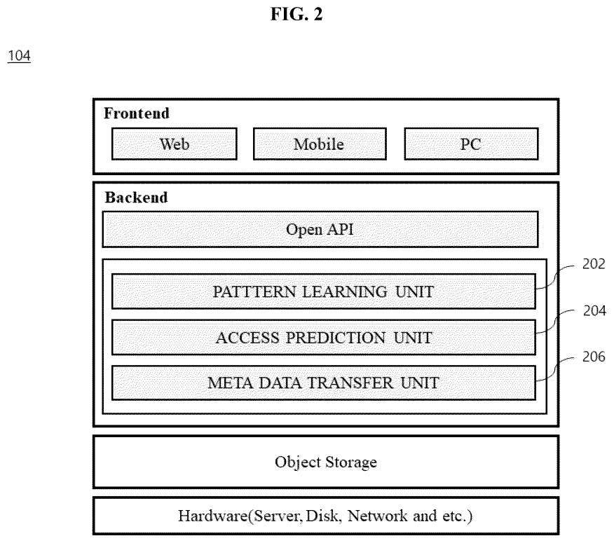

At this time, the cloud server 104 is configured not to transfer meta data on the entire folder tree, that is, all folders included in the folder tree, to the local terminal 102 at once, but to determine one or more folders predicted to be accessed next by the local terminal 102 after initially accessing a specific folder in the folder tree, and dynamically perform the transfer of the meta data based on the one or more folders. In addition, the local terminal 102 may dynamically display only a portion of the folder tree on the basis of the meta data received from the cloud server 104 rather than displaying the entire folder tree at once. In this case, the viewing speed of the folder tree in the local terminal 102 is improved, and since only the folder predicted to be accessed by the user is selectively displayed, it is possible to enable more efficient viewing on a limited-size screen. Hereinafter, referring to FIG. 2 to FIG. 15, such a dynamic pre-fetch configuration of a folder tree will be described in more detail.

FIG. 2 is a block diagram showing a detailed configuration of the cloud server 104 in accordance with an exemplary embodiment of the present disclosure. As illustrated in FIG. 2, the cloud server 104 according to an embodiment of the present disclosure includes a pattern learning unit 202, an access prediction unit 204, and a meta data transfer unit 206.

The pattern learning unit 202 learns access patterns of users who access a folder tree. Specifically, the pattern learning unit 202 may learn the access patterns of the users by mutually matching information on a user who accesses the folder tree with information on a folder accessed by the user, that is, folder information. Here, the user information may be, for example, the user's affiliation, position, job duties, and the like. In addition, the folder information may be, for example, a folder path through which the user has accessed the folder tree for a set period of time, the number of folders accessed, the access time, and the like.

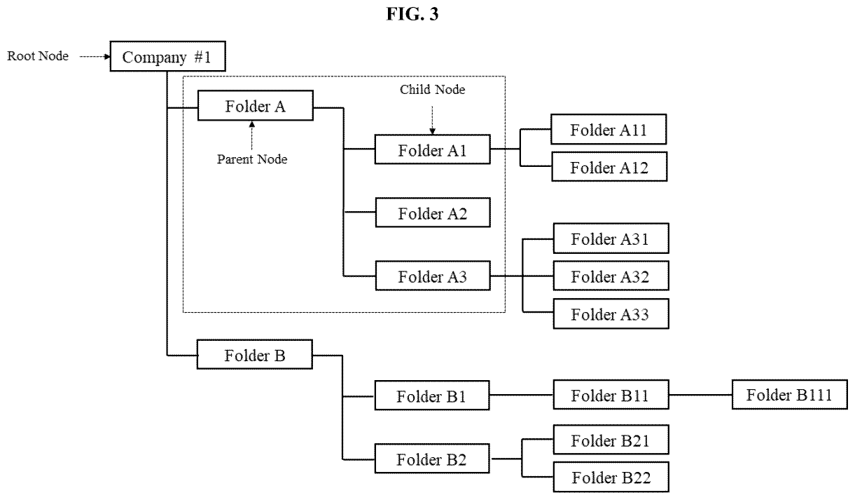

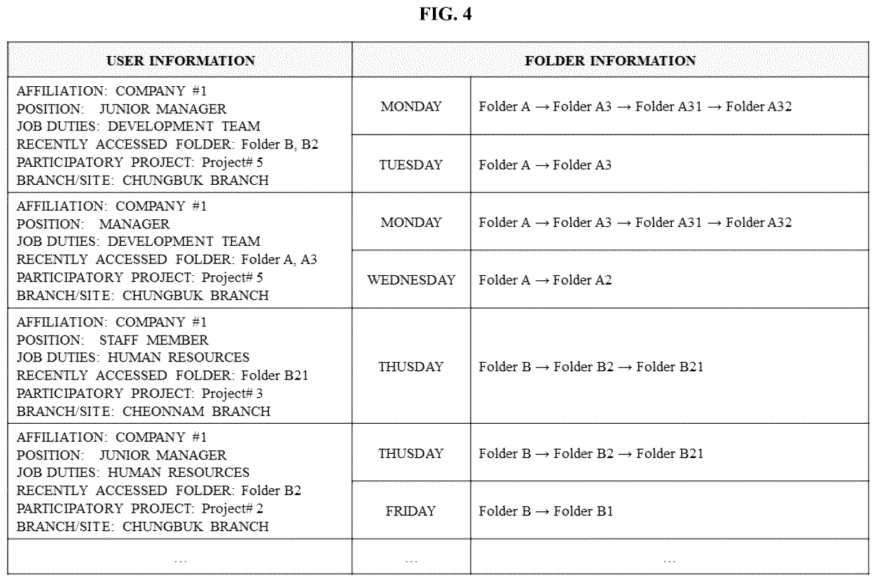

FIG. 3 is an example of a folder tree in accordance with an exemplary embodiment of the present disclosure, and FIG. 4 is an example showing access patterns of users in accordance with an exemplary embodiment of the present disclosure.

Referring to FIG. 3, the folder tree may be composed of a root node, a parent node, and a child node. The root node refers to a node without a parent node. In addition, the parent node refers to an upper node in relation to the child node, and the root node refers to a lower node in relation to the parent node. The parent node may become a child node in relation to the upper mode, and similarly, the child node may become a parent node in relation to the lower node. In addition, nodes having the same level as each other, for example, Folder A1, Folder A2, and Folder A3, may be represented as sibling nodes in the relationship therebetween.

Referring to FIG. 4, the pattern learning unit 202 may learn access patterns of users who access a folder tree. As described above, the pattern learning unit 202 may learn the access patterns of the users by mutually matching the user information with the folder information. Here, the user information may be, for example, a user's affiliation (ex. Company #1), position (ex. Junior Manager), job duties (ex. Development Team), recently used folder (ex. Folder B), participatory project (ex. Project #5), branch/site information (ex. Chungbuk branch), and the like. In addition, the folder information may include a folder path (ex. Folder A→Folder A3→Folder A31→Folder A32), number of folders (ex. 4 folders), access time zone (ex. access day such as Monday/Tuesday, etc., access month such as January/February, etc., and the like).

The pattern learning unit 202 may learn the access patterns of the users by collecting the user information and the folder information through an artificial intelligence model for a set period of time. At this time, the pattern learning unit 202 may collect and learn the access pattern of users in the descending order of the number of accesses or ratios. The access patterns of the users may be used in the access prediction unit 204 to be described later to determine a folder predicted to be accessed by the local terminal 102.

Referring back to FIG. 2, when the local terminal 102 initially accesses a first folder in a folder tree, the access prediction unit 204 determines one or more second folders predicted to be accessed by the local terminal 102 after accessing the first folder based on information on the first folder, information on the local terminal 102, and learning data learned in the pattern learning unit 202.

To this end, from the user information, the access prediction unit 204 may select another local terminal corresponding to the information on the local terminal 102. Specifically, the access prediction unit 204 may select another local terminal corresponding to the information on the local terminal 102 by respectively comparing the affiliation, position, and job duties of a user carrying the local terminal 102 with the affiliation, position, and job duties of a user carrying the another local terminal. That is, the access prediction unit 204 may select another local terminal corresponding to the user information of the local terminal 102. For example, when the user information of the local terminal 102 includes Company #1, and Development Team, the access prediction unit 204 may select another local terminal corresponding to Company #1, and Development Team. In addition, the access prediction unit 204 may select another local terminal corresponding to the information of the local terminal 102 by additionally comparing the recently used folder, participatory project, and branch office/site information of the user carrying the local terminal 102 with the recently used folder, participatory project, and branch office/site information of the user carrying the another local terminal.

Thereafter, from the folder information, the access prediction unit 204 may determine the second folder in consideration of the count or ratio of accesses with respect to a folder accessed next by the another local terminal after accessing the first folder. For example, when it is determined that the count or ratio of accesses with respect to Folder A3→Folder A31→Folder A32 was the highest as a result of analyzing access patterns with respect to folders accessed next by the another local terminal after accessing the first folder (ex. Folder A), the access prediction unit 204 may determine Folder A3, Folder A31, and Folder A32 as second folders. As described above, the access prediction unit 204 may determine, as the second folder, one or more folders having the highest count or ratio of accesses with respect to a folder accessed next by the another local terminal after accessing the first folder.

At this time, the access prediction unit 204 may determine the second folder by additionally considering an access time zone as well as the count or ratio of accesses. As an example, when there are a plurality of sets of folders in which the count or ratio of accesses with respect to a folder accessed next by the another local terminal after accessing the first folder is greater than or equal to a reference value, the access prediction unit 204 may determine, as the second folder, one or more folders having the highest count or ratio of accesses with respect to the folder accessed next by the another local terminal after accessing the first folder in a time zone corresponding to the time at which the local terminal 102 has accessed the first folder.

In addition, when the local terminal 102 sequentially accesses one or more other folders other than the first folder in the folder tree after initially accessing the first folder, the access prediction unit 204 may determine the second folder based on the information on the first folder, information on the other folders, the information on the local terminal 102, and the learning data learned in the pattern learning unit 202.

As an example, when the local terminal 102 first accesses Folder A, and then sequentially accesses Folder A1, and Folder A2, the access prediction unit 204 may newly determine the second folder whenever the local terminal 102 accesses Folder A1, and Folder A2 from Folder A, respectively. If the local terminal 102 performs an access of Folder A→Folder A1, the access prediction unit 204 may determine Folder A2 as a second folder. In addition, if the local terminal 102 performs an access of Folder A→Folder A1→Folder A2, the access prediction unit 204 may determine Folder A11 and Folder A12 as second folders. As described above, whenever the local terminal 102 accesses each folder in the folder tree, the access prediction unit 204 may newly determine a second folder predicted to be accessed based on information on folders which have been accessed so far, the information of the local terminal 102, and the learning data.

The meta data transfer unit 206 transfers meta data on the second folder to the local terminal 102 so as to allow the local terminal 102 to pre-fetch the meta data on the second folder before accessing the second folder. Referring to FIG. 2, the meta data transfer unit 206 may transfer the meta data on the second folder to the local terminal 102 through an application programming interface (API) corresponding to each application (e.g., web, mobile, and PC) of a front end. The meta data on the second folder may be, for example, the name of a second folder, and the name, number, size, extension, etc., of a file included in the second folder. The local terminal 102 pre-fetches the meta data on the second folder before accessing the second folder, and thus, may display the second folder on a screen based on the meta data. That is, based on the meta data on the second folder, the local terminal 102 may display the second folder before accessing the second folder, and accordingly, a user may quickly check a desired folder without the pre-fetch for the entire folder tree.

The meta data on the second folder may be dynamically changed according to user information corresponding to each local terminal 102 and a pre-fetch request time zone of the each local terminal 102. In addition, the folder tree may be dynamically displayed in the local terminal 102 according to the meta data. That is, folders in the folder tree may be displayed differently from each other in the local terminal 102 according to whether the meta data is received. As an example, the same folder tree may be displayed differently for each local terminal 102 according to user information of the local terminal 102. As another example, the folder tree may be displayed differently even in one local terminal 102 according to an access time zone.

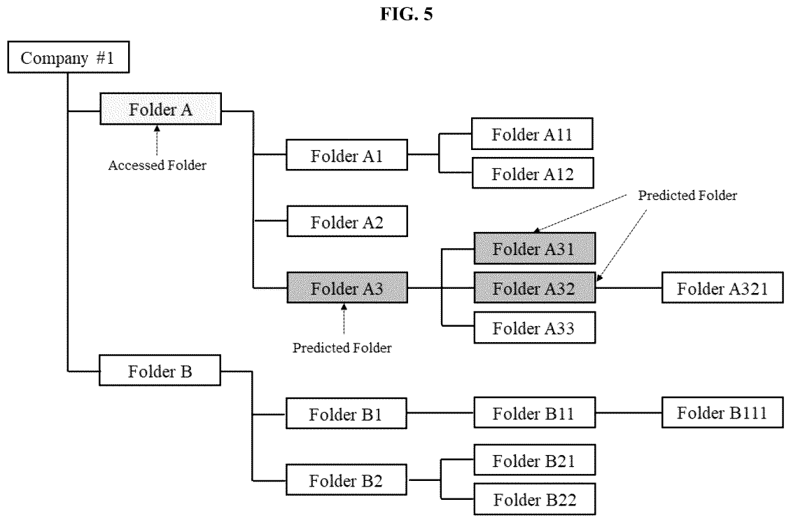

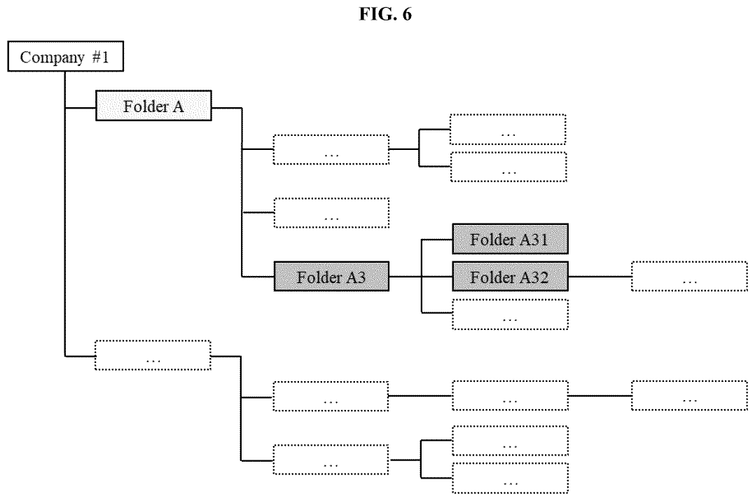

FIG. 5 is a diagram showing a process of predicting an access to a second folder in the access prediction unit 204 according to a first embodiment of the present disclosure. In addition, FIG. 6 is a diagram showing a process of transferring meta data on the second folder from the meta data transfer unit 206 to the local terminal 102, and dynamically viewing a folder tree in the local terminal 102 according to the first embodiment of the present disclosure.

Referring to FIG. 5, if it is assumed that a first folder that the local terminal 102 initially accesses in the folder tree is Folder A, the access prediction unit 204 may predict that the local terminal 102 will access Folder A3, Folder A31, and Folder A32 based on information on the first folder, information of the local terminal, and learning data learned in the pattern learning unit. That is, the access prediction unit 102 may determine Folder A3, Folder A31, and Folder A32 as second folders.

Referring to FIG. 6, the meta data transfer unit 206 may transfer meta data on the second folder, that is, meta data on Folder A3, Folder A31, and Folder A32, to the local terminal 102. In this case, based on the meta data, the local terminal 102 may display Folder A, Folder A3, Folder A31, and Folder A32 normally, and may display the remaining folders differently. For example, the local terminal 102 may display Folder A, Folder A3, Folder A31, and Folder A32 with solid lines, and may display the remaining folders with dotted lines. In addition, the local terminal 102 may display Folder A, Folder A3, Folder A31, and Folder A32 with the names of the folders, and may display the remaining folders without names. As such, the folder tree may be dynamically displayed in the local terminal 102 according to the meta data, and each folder may be differently displayed in the local terminal 102 according to whether the meta data is received.

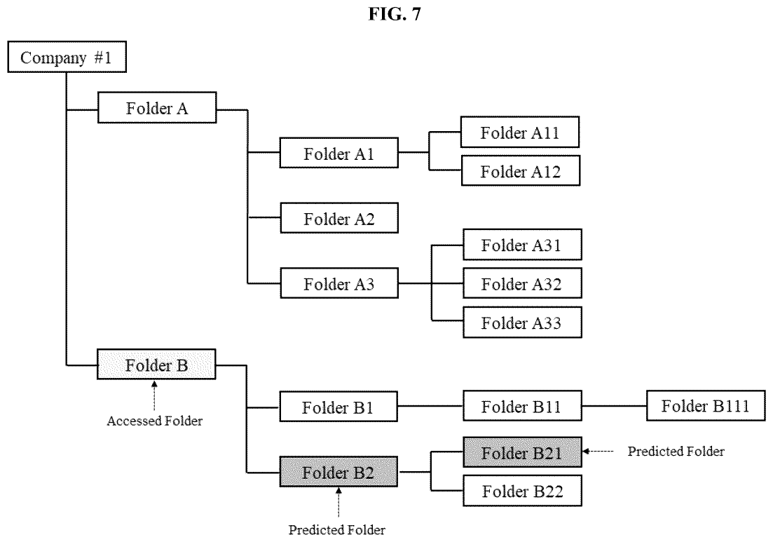

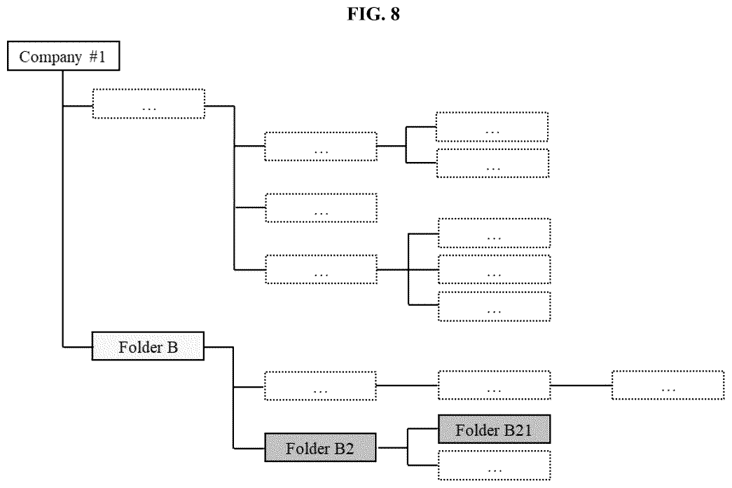

FIG. 7 is a diagram showing a process of predicting an access to a second folder in the access prediction unit 204 according to a second embodiment of the present disclosure. In addition, FIG. 8 is a diagram showing a process of transferring meta data on the second folder from the meta data transfer unit 206 to the local terminal 102, and dynamically viewing a folder tree in the local terminal 102 according to the second embodiment of the present disclosure.

Referring to FIG. 7, if it is assumed that a first folder that the local terminal 102 initially accesses in the folder tree is Folder B, the access prediction unit 204 may predict that the local terminal 102 will access Folder B2, and Folder B21 based on information on the first folder, information of the local terminal, and learning data learned in the pattern learning unit. That is, the access prediction unit 102 may determine Folder B2, and Folder B21 as second folders.

Referring to FIG. 8, the meta data transfer unit 206 may transfer meta data on the second folder, that is, meta data on Folder B2, and Folder B21, to the local terminal 102. In this case, based on the meta data, the local terminal 102 may display Folder B2, and Folder B21 normally, and may display the remaining folders differently. For example, the local terminal 102 may display Folder B2, and Folder B21 with solid lines, and may display the remaining folders with dotted lines. In addition, the local terminal 102 may display Folder B2, and Folder B21 with the names of the folders, and may display the remaining folders without names. As such, the folder tree may be dynamically displayed in the local terminal 102 according to the meta data, and each folder may be differently displayed in the local terminal 102 according to whether the meta data is received.

In addition, the meta data transfer unit 206 may transfer not only the meta data on the second folder but also meta data on a folder (i.e., a folder at the position of a sibling node) positioned at the same level as the second folder to the local terminal 102. In this case, the local terminal 102 may display the second folder, folders positioned at the same level as the second folder, and the remaining folders differently from each other. For example, the local terminal 102 may display the names for the second folder and the folders positioned at the same level as the second folder, and may not display names for the remaining folders. In addition, the local terminal 102 may display the second folder and the folders positioned at the same level as the second folder with solid lines, and may display the remaining folders with dotted lines.

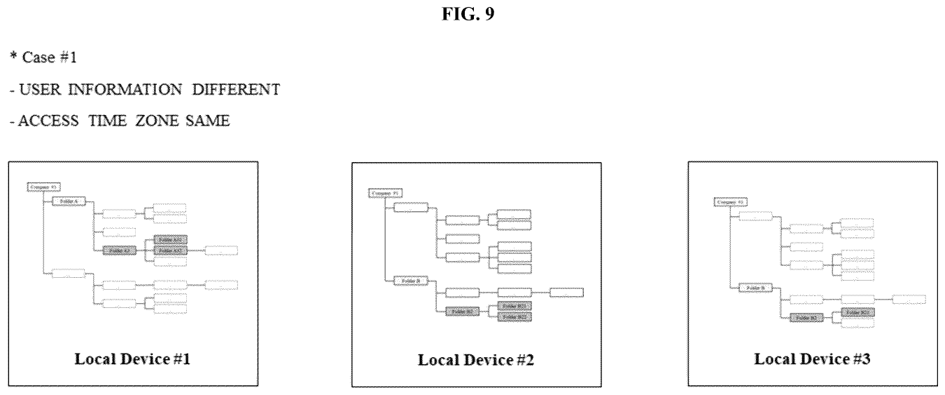

FIG. 9 is an example in which a folder tree in accordance with an exemplary embodiment of the present disclosure is viewed differently according to user information of each local terminal 102. Here, it is assumed that the user information of each local terminal 102 is different, and an access time for a folder tree of each local terminal 102, that is, a pre-fetch request time zone, is the same.

Referring to FIG. 9, since the user information of each local terminal 102 is different, it can be confirmed that folders in the folder tree are displayed differently for each local terminal 102.

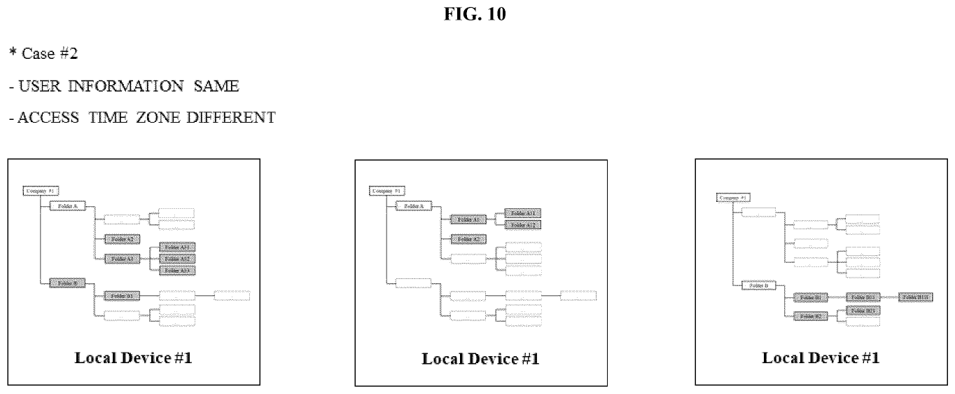

FIG. 10 is an example in which a folder tree in accordance with an exemplary embodiment of the present disclosure is viewed differently according to an access time zone of each local terminal. Here, it is assumed that the user information of each local terminal 102 is the same, and an access time for a folder tree of each local terminal 102, that is, a pre-fetch request time zone, is different.

Referring to FIG. 10, since the access time zone for the folder tree of the local terminal 102 is different, it can be confirmed that folders in the folder tree are displayed differently according to each access time zone.

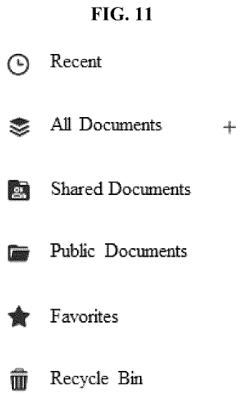

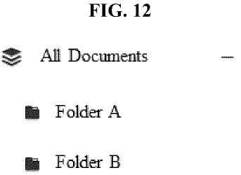

FIG. 11 is an example showing a user interface for opening a folder tree in accordance with an exemplary embodiment of the present disclosure, and FIG. 12 is an example showing a state in which a folder tree is open according to the user interface of FIG. 11.

Referring to FIG. 11, a user may open a folder tree by, for example, clicking a “+” button.

Referring to FIG. 12, in response to the click of the “+” button by the used, upper folders which are initially accessible by the user may be displayed on a screen. When a user initially accesses an arbitrary folder in the folder tree, the above-described dynamic pre-fetch process of a folder tree is operated.

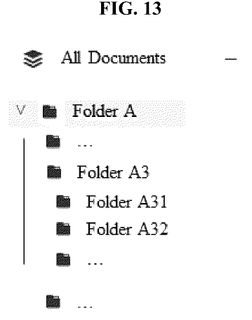

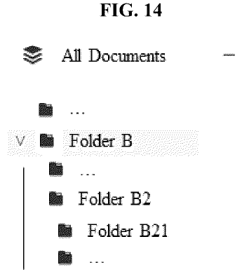

FIG. 13 and FIG. 14 are diagrams showing an example of displaying a sub-folder in a folder tree in accordance with an exemplary embodiment of the present disclosure.

Referring to FIG. 13, when a user initially clicks Folder A to access the same, sub-folders with respect to Folder A may be displayed on a screen along with a vertical line positioned on the left side of the sub-folders. At this time, the above-described dynamic pre-fetch process may be operated so that Folder A3, Folder A31, and Folder A32, which are determined to be predicted by the user next, may be displayed on a screen together with the Folder A, and the remaining folders may be displayed differently therefrom. For example, the remaining folders may be displayed in the form of “ . . . ” without folder names displayed on the screen.

In addition, referring to FIG. 14, when a user initially clicks Folder B to access the same, sub-folders with respect to Folder B may be displayed on a screen along with a vertical line positioned on the left side of the sub-folders. At this time, the above-described dynamic pre-fetch process may be operated so that Folder B2, and Folder B21, which are determined to be predicted by the user next, may be displayed on a screen together with the Folder B, and the remaining folders may be displayed differently therefrom. For example, the remaining folders may be displayed in the form of “ . . . ” without folder names displayed on the screen. Here, when the folders omittedly marked as “ . . . ” are clicked, the folder names of the omitted folders may be displayed.

As described above, since the sub-folders predicted to be accessed by the user are selectively displayed on the screen and the vertical line indicating the start and end of the sub-folders is displayed together with the sub-folders, the user may more efficiently view on a limited-size screen, and may more intuitively check the status of a sub-folder with respect to a specific folder.

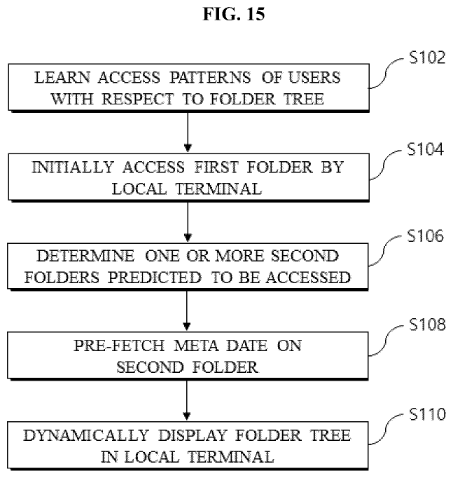

FIG. 15 is a flowchart for describing a method for dynamically pre-fetching a folder tree in accordance with another exemplary embodiment of the present disclosure. In the illustrated flowchart, the method is disclosed by being divided into a plurality of steps, but at least some of the steps may be performed in a different order, performed by being combined with other steps, omitted, performed by being divided into detailed steps, or performed by being added with one or more steps not illustrated.

In Step S102, the pattern learning unit 202 learns access patterns of users who access a folder tree.

In Step S104 and in Step S106, when the local terminal 102 initially accesses a first folder in the folder tree, the access prediction unit 204 determines one or more second folders predicted to be accessed by the local terminal 102 after accessing the first folder based on information on the first folder, information on the local terminal 102, and learning data learned in the pattern learning unit 202.

In Step S108, the meta data transfer unit 206 transfers meta data on the second folder to the local terminal 102 so as to allow the local terminal 102 to pre-fetch the meta data on the second folder before accessing the second folder.

In Step S110, the local terminal 102 dynamically displays a folder tree based on the meta data.

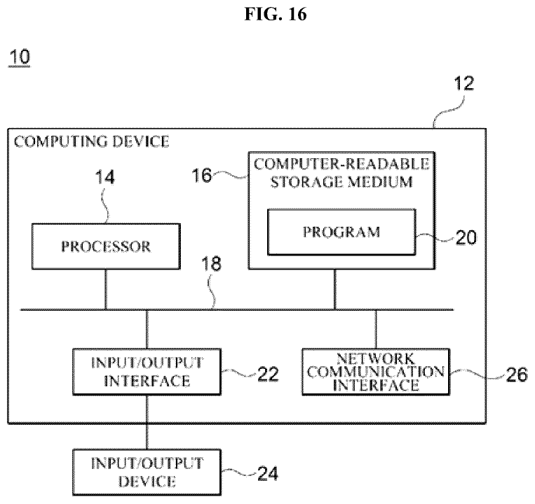

FIG. 16 is a block diagram for illustrating and describing a computing environment including a computing device suitable to be used in exemplary embodiments. In an embodiment illustrated, each component may have a function or ability different from those described below, and an additional component may be included in addition to those described below.

A computing environment 10 illustrated includes a computing device 12. In an embodiment, the computing device 12 may be a dynamic pre-fetch system 100 of a folder tree, or one or more components included in the dynamic pre-fetch system 100 of a folder tree.

The computing device 12 includes at least one processor 14, a computer-readable storage medium 16, and a communication bus 18. The processor 14 may enable the computing device 12 to operate according to the exemplary embodiment mentioned above. For example, the processor 14 may execute one or more programs stored in the computer-readable storage medium 16. The one or more programs may include one or more computer-executable commands, and when executed by the processor 14, the computer-executable command may be configured to enable the computing device 12 to perform operations according to the exemplary embodiment.

The computer-readable storage medium 16 is configured to store computer-executable commands or program codes, program data, and/or other suitable types of information. A program 20 stored in the computer-readable storage medium 16 includes a set of commands executable by the processor 14. In an embodiment, the computer-readable storage medium 16 may be a memory (a volatile memory such as a random access memory, a non-volatile memory, or a suitable combination thereof), one or more magnetic disk storage devices, optical disk storage devices, flash memory devices, other types of storage media accessed by the computing device 12 and capable of storing desired information, or any suitable combination thereof.

The communication bus 18 includes the processor 14 and the computer-readable storage medium 16 to interconnect various other components of the computing device 12.

The computing device 12 may also include one or more input/output interfaces 22 which provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or track pad), a keyboard, a touch input device (such as a touch pad or touch screen), a voice or sound input device, an input device such as various types of sensor devices and/or photographing devices, and/or an output device such as a display device, a printer, a speaker, and/or a network card. The exemplary input/output device 24 may be included inside the computing device 12 as one component constituting the computing device 12, or may be connected to the computing device 12 as a separate device distinct from the computing device 12.

According to embodiments of the present disclosure, by learning access patterns of users who access a folder tree, and when a local terminal initially accesses a first folder in the folder tree, by determining a second folder predicted to be accessed by the local terminal after accessing the first folder based on information on the first folder, information on the local terminal, and learning data, it is possible to specify a position in the folder tree that the local terminal is predicted to access before the access of the local terminal.

In addition, according to embodiments of the present disclosure, by transferring meta data on a second folder to the local terminal before the local terminal accesses the second folder, it is possible to improve the viewing speed of the folder tree in the local terminal.

In addition, according to embodiments of the present disclosure, by differently displaying folders from each other in the folder tree according to whether the local terminal has received the meta data or not, it is possible to selectively display only the folder predicted to be accessed by a user, and accordingly, it is possible to enable more efficient viewing on a limited-size screen.

Although the present disclosure has been described in detail with reference to the representative embodiment, it will be understood by a person skilled in the art that various modifications are possible without departing from the scope of the present disclosure with respect to the aforementioned embodiments. Therefore, the scope of rights of the present disclosure should not be limited to the described embodiments, but should be defined not only by claims set forth below but also by equivalents of the claims.

What is claimed is:

1. A cloud server having a folder tree and transferring meta data on one or more folders included in the folder tree to a local terminal in response to a pre-fetch request of the local terminal, the cloud server comprising:
a pattern learning unit configured to learn access patterns of users who access the folder tree;
an access prediction unit configured to, when the local terminal initially accesses a first folder in the folder tree, determine one or more second folders predicted to be accessed by the local terminal after accessing the first folder based on information on the first folder, information on the local terminal, and learning data learned in the pattern learning unit; and
a meta data transfer unit configured to transfer meta data on the second folder to the local terminal so as to allow the local terminal to pre-fetch the meta data on the second folder before accessing the second folder.

2. The cloud server of claim 1, wherein the pattern learning unit is configured to learn the access patterns of the users by matching user information including at least one of a user's affiliation, position, and job duties with folder information including at least one of a folder path through which the user has accessed the folder tree for a set period of time, the number of folders accessed, and an access time zone during which the user has accessed the folder tree.

3. The cloud server of claim 2, wherein the access prediction unit is configured to select another local terminal corresponding to information on the local terminal from the user information, and to determine from the folder information the second folder in consideration of the count or ratio of accesses with respect to a folder accessed next by the another local terminal after accessing the first folder.

4. The cloud server of claim 3, wherein the access prediction unit is configured to select another local terminal corresponding to the information on the local terminal by respectively comparing the affiliation, position, and job duties of a user carrying the local terminal with the affiliation, position, and job duties of a user carrying the another local terminal.

5. The cloud server of claim 1, wherein, when the local terminal sequentially accesses one or more other folders other than the first folder in the folder tree after initially accessing the first folder, the access prediction unit is configured to determine the second folder based on the information on the first folder, information on the other folders, the information on the local terminal, and the learning data learned in the pattern learning unit.

6. The cloud server of claim 5, wherein the meta data on the second folder is configured to be dynamically changed according to user information corresponding to each local terminal and a pre-fetch request time zone of the each local terminal.

7. The cloud server of claim 6, wherein the folder tree is configured to be dynamically displayed in the local terminal according to the meta data, wherein folders in the folder tree are displayed differently from each other in the local terminal according to whether the meta data is received.

8. A method for dynamically pre-fetching a folder tree provided in a cloud server having a folder tree and receiving a pre-fetch request for the folder tree from a local terminal, the method comprising:
in a pattern learning unit, learning access patterns of users who access the folder tree;
in an access prediction unit, when the local terminal initially accesses a first folder in the folder tree, determining one or more second folders predicted to be accessed by the local terminal after accessing the first folder based on information on the first folder, information on the local terminal, and learning data learned in the pattern learning unit; and
in a meta data transfer unit, transferring meta data on the second folder to the local terminal so as to allow the local terminal to pre-fetch the meta data on the second folder before accessing the second folder.

9. The method of claim 8, wherein the learning of the access patterns is learning the access patterns of the users by matching user information including at least one of a user's affiliation, position, and job duties with folder information including at least one of a folder path through which the user has accessed the folder tree for a set period of time, the number of folders accessed, and an access time zone during which the user has accessed the folder tree.

10. The method of claim 9, wherein the determining of the second folder comprises:
selecting another local terminal corresponding to the information on the local terminal from the user information; and
determining the second folder from the folder information in consideration of the count or ratio of accesses with respect to a folder accessed next by the another local terminal after accessing the first folder.

11. The method of claim 10, wherein the selecting of the another local terminal comprises selecting another local terminal corresponding to the information on the local terminal by respectively comparing the affiliation, position, and job duties of a user carrying the local terminal with the affiliation, position, and job duties of a user carrying the another local terminal.

12. The method of claim 8, wherein the determining of the second folder comprises determining, when the local terminal sequentially accesses one or more other folders other than the first folder in the folder tree after initially accessing the first folder, the second folder based on the information on the first folder, information on the other folders, the information on the local terminal, and the learning data learned in the pattern learning unit.

13. The method of claim 12, wherein the meta data on the second folder is configured to be dynamically changed according to user information corresponding to each local terminal and a pre-fetch request time zone of the each local terminal.

14. The method of claim 13, wherein the folder tree is configured to be dynamically displayed in the local terminal according to the meta data, wherein folders in the folder tree are displayed differently from each other in the local terminal according to whether the meta data is received.
